(19) United States
(12) Patent Application Publication
(10) Pub. No.: US 2017/0160604 A1
(43) Pub. Date: Jun. 8, 2017

(54) THIN FILM TRANSISTOR ARRAY SUBSTRATE, LIQUID CRYSTAL DISPLAY PANEL AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventor: Xiao WANG, Beijing (CN)

(21) Appl. No.: 15/325,055

(22) PCT Filed: Mar. 16, 2016
(86) PCT No.: PCT/CN2016/076439

§ 371 Date: Jan. 9, 2017

(30) Foreign Application Priority Data
Apr. 8, 2015 (CN) 201510164168.0

(51) Int. Cl. G02F 1/1343; G02F 1/1362

(52) U.S. Cl. CPC G02F 1/134336; G02F 1/136213; G02F 2001/134354; G09G 2320/0219

(57) ABSTRACT

The present disclosure relates to a thin film transistor array substrate, a liquid crystal display panel and a display device. The thin film transistor array substrate comprises: a base substrate, and arranged on the base substrate, a common electrode and a plurality of subpixel units in a matrix. Two gate signal lines are provided between two adjacent rows of subpixel units, and two adjacent columns of subpixel units form a set of subpixel unit columns. Each set of the subpixel unit columns sharing a data signal line located between two columns of subpixel units. The thin film transistor array substrate further comprises: at least one metal wire arranged in a gap between adjacent sets of the subpixel unit columns and connected to a low-level potential. A projection of the metal wire on the base substrate and a projection of the common electrode on the base substrate have an overlapping region.

### FIELD

The present disclosure relates to the field of display technologies, and in particular to a thin film transistor array substrate, a liquid crystal display panel and a display device.

### BACKGROUND ART

In recent years, liquid crystal display devices have replaced conventional cathode ray tube displays and have been widely applied in various electronic products for being light, thin, energy-saving and non-radiative.

A thin film transistor (TFT) array substrate of an existing liquid crystal display panel comprises a plurality of gate signal lines and a plurality of data signal lines. A region enclosed by any two adjacent gate signal lines and any two adjacent data signal lines forms a subpixel unit, and each subpixel unit has a corresponding pixel electrode and common electrode. In a display mode, by changing electric signals loaded on the gate signal lines and the data signal lines, a voltage on the pixel electrode is controlled, and by applying a DC voltage to the common electrode via common electrode lines, an electric field is generated therebetween, so as to control overturns of the liquid crystal, and thereby achieve a display function.

For a large-sized and full-high-definition panel with advanced super dimension switch (ADS) techniques, loads of the display panel will be very heavy, because of high resolution and a large Cst (a storage capacitor between the pixel electrode and the common electrode) of ADS pixels. In case of changes in a signal polarity of the data signal lines, coupling between signals on the common electrode and signals on the data signal lines may occur, which will result in large fluctuations in the DC voltage of the common electrode as shown in FIG. 1. The larger the fluctuations in the DC voltage of the common electrode are, the more likely images of the liquid crystal screen will become greenish, i.e., the so-called Greenish effect. Especially, the Greenish effect will become more severe as the size of the liquid crystal screen increases.

Therefore, how to improve the Greenish effect of liquid crystal display panels is an urgent technical problem to be solved by those skilled in the art.

### SUMMARY

To this end, embodiments of the present disclosure provide a thin film transistor array substrate, a liquid crystal display panel and a display device for improving the Greenish effect of liquid crystal display panels.

Therefore, embodiments of the present disclosure provide a thin film transistor array substrate, comprising: a base substrate, a common electrode arranged on the base substrate and a plurality of subpixel units arranged in a matrix on the base substrate, wherein two gate signal lines are provided between any two adjacent rows of subpixel units, and any two adjacent columns of subpixel units form a set of subpixel unit columns, each set of the subpixel unit columns sharing a data signal line located between two columns of subpixel units. The thin film transistor array substrate further comprises: at least one metal wire arranged in a gap between adjacent sets of the subpixel unit columns and connected to a low-level potential, wherein a projection of the metal wire on the base substrate and a projection of the common electrode on the base substrate have an overlapping region.

In a possible implementation, in the thin film transistor array substrate provided in the embodiments of the present disclosure, the metal wire is connected with a ground point of an external printed circuit board (PCB).

In a possible implementation, in the thin film transistor array substrate provided in the embodiments of the present disclosure, the metal wire is arranged in a same layer as the data signal lines, and the common electrode is arranged in a same layer as the gate signal lines.

In a possible implementation, the thin film transistor array substrate provided in the embodiments of the present disclosure further comprises, in addition to the metal wire, at least one perpendicular common electrode line arranged in a gap between adjacent sets of the subpixel unit columns, wherein each perpendicular common electrode line is electrically connected with a corresponding common electrode through at least one via.

In a possible implementation, in the thin film transistor array substrate provided in the embodiments of the present disclosure, the perpendicular common electrode line is arranged in a same layer as the data signal lines.

In a possible implementation, in the thin film transistor array substrate provided in the embodiments of the present disclosure, a pixel electrode in the thin film transistor array substrate is located above the common electrode, and the common electrode has a plate structure in a position corresponding to an opening region of each subpixel unit.

In a possible implementation, in the thin film transistor array substrate provided in the embodiments of the present disclosure, a pixel electrode in the thin film transistor array substrate is located below the common electrode, and the common electrode has a slit structure or a mesh structure in a position corresponding to an opening region of each subpixel unit.

Embodiments of the present disclosure further provide a liquid crystal display panel, comprising the thin film transistor array substrate provided in the above embodiments of the present disclosure.

Embodiments of the present disclosure further provide a display device, comprising the liquid crystal display panel provided in the above embodiments of the present disclosure.

Embodiments of the present disclosure provide a thin film transistor array substrate, a liquid crystal display panel and a display device. The thin film transistor array substrate comprises: a base substrate, a common electrode arranged on the base substrate and a plurality of subpixel units arranged in a matrix on the base substrate, wherein two gate signal lines are provided between two adjacent rows of subpixel units, and two adjacent columns of subpixel units form a set of subpixel unit columns, each set of the subpixel unit columns sharing a data signal line located between two columns of subpixel units. The thin film transistor array substrate further comprises: at least one metal wire arranged in a gap between adjacent sets of the subpixel unit columns and connected to a low-level potential, wherein a projection of the metal wire on the base substrate and a projection of the common electrode on the base substrate have an overlapping region. In this way, a filter capacitor is formed between the metal wire and the common electrode in the overlapping region, for filtering signals on the common electrode, which reduces coupling between signals on the data signal lines and signals on the common electrode and stabilizes signals on the common electrode. As a result, the Greenish effect is effectively improved and the image quality of the display panel is greatly enhanced. Besides, since the metal wire is arranged in a position at a gap between adjacent sets of the subpixel unit columns, it will not influence the aperture ratio.

### BRIEF DESCRIPTION OF DRAWINGS

FIG. 1 is schematic view for voltage fluctuations on a common electrode in the prior art;

FIG. 2 is a schematic structural view for a thin film transistor array substrate provided in the embodiments of the present disclosure;

FIG. 3 is an equivalent circuit diagram for a filter capacitor provided in the embodiments of the present disclosure;

FIG. 4 is another schematic structural view for a thin film transistor array substrate provided in the embodiments of the present disclosure;

FIG. 5 is a circuit diagram for a filter capacitor of a thin film transistor array substrate provided in the embodiments of the present disclosure; and

FIG. 6 is a schematic view for voltage fluctuations on a filtered common electrode provided in the embodiments of the present disclosure.

### DETAILED DESCRIPTION OF EMBODIMENTS

With reference to the drawings, specific implementations of the thin film transistor array substrate, the liquid crystal display panel and the display device provided in embodiments of the present disclosure will be explained in detail as follows.

Shapes and sizes of each region in the drawings are not provided to reflect the true proportion of the thin film transistor array substrate, but only for the purpose of illustrating contents of the present disclosure.

Embodiments of the present disclosure provide a thin film transistor array substrate as shown in FIG. 2. The thin film transistor array substrate may comprise: a base substrate, a common electrode and a plurality of subpixel units arranged in a matrix, the common electrode and a plurality of subpixel units both being arranged on the base substrate. Two gate signal lines 001 may be provided between any two adjacent rows of subpixel units, and any two adjacent columns of subpixel units may form a set of subpixel unit columns, each set of the subpixel unit columns sharing a data signal line 002 located between two columns of subpixel units. The thin film transistor array substrate may further comprise: at least one metal wire 003 arranged in a gap between adjacent sets of the subpixel unit columns and connected to a low-level potential, wherein a projection of the metal wire 003 on the base substrate and a projection of the common electrode on the base substrate may have an overlapping region.

In the thin film transistor array substrate provided in the embodiments of the present disclosure, since the projection of the metal wire connected to a low-level potential on the base substrate and the projection of the common electrode on the base substrate have an overlapping region, a filter capacitor will be formed between the metal wire and the common electrode in the overlapping region. The filter capacitor can filter signals on the common electrode, which reduces coupling between signals on the data signal lines and signals on the common electrode and stabilizes signals on the common electrode. As a result, the Greenish effect will be effectively improved and the image quality of the display panel is greatly enhanced. Besides, since the metal wire is arranged in a position at a gap between adjacent sets of the subpixel unit columns, it will not influence the aperture ratio.

In a specific embodiment, in the thin film transistor array substrate provided in the embodiments of the present disclosure, in order that the filter capacitor formed between the metal wire connected to a low-level potential and the common electrode can operate properly, the metal wire can be connected with a ground point of an external printed circuit board (PCB), and thereby a ground signal serves as a low-level signal. Specific choices for a capacitance value of the filter capacitor will depend on a primary operational frequency of the PCB and a spectrum frequency influencing the system.

In a specific embodiment, in the thin film transistor array substrate provided in the embodiments of the present disclosure, the metal wire can be arranged in a same layer as the data signal lines, and the common electrode can be arranged in a same layer as the gate signal lines. In this way, no additional manufacturing process will be required for the manufacture of a TFT array substrate. Specifically, it is only necessary to perform a one-time patterning process so as to form patterns of the metal wire and the data signal lines, and it is only necessary to perform a one-time patterning process so as to form patterns of the common electrode and the gate signal lines. Therefore, the manufacture cost can be saved and the added value of a product will be promoted.

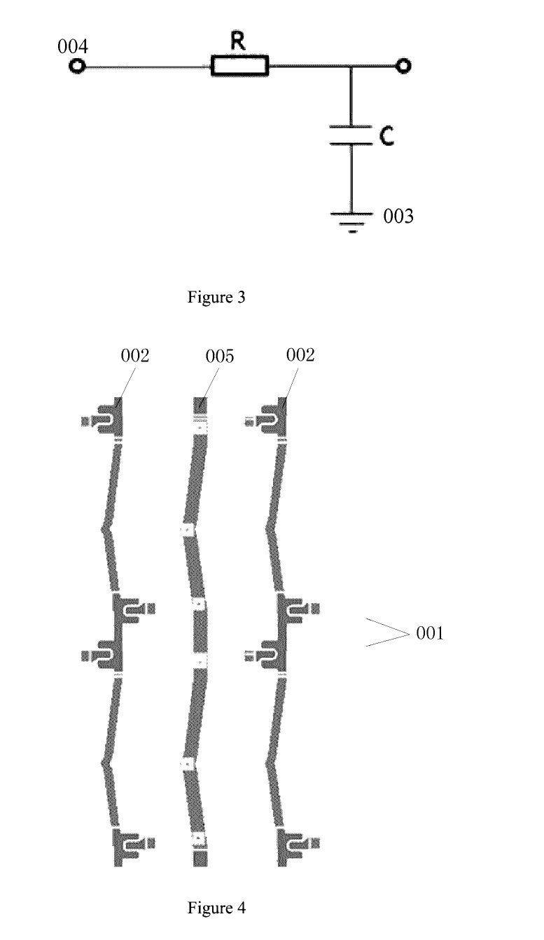

It should be noted that since the metal wire is arranged in a same layer as the data signal lines, and a source-drain of the TFT is also arranged in the same layer as the data signal lines, the metal wire will be also arranged in the same layer as the source-drain of the TFT. Again, since the common electrode is arranged in a same layer as the gate signal lines, and a gate of the TFT is also arranged in the same layer as the gate signal lines, the common electrode will be also arranged in the same layer as the gate. As a gate insulating layer between the gate and the source-drain of the TFT is dielectric, a filter capacitor will be formed between the metal wire and the common electrode in the overlapping region, for filtering signals on the common electrode. An equivalent circuit diagram for the filter capacitor is shown in FIG. 3, wherein resistance R is an equivalent resistance for a common electrode 004. When the filtering effect is adjusted by a size adjustment of the filter capacitor, the size of the filter capacitor can be controlled by an area of the overlapping region. Specifically, C=ε·S/d, wherein C is a size of the filter capacitor, ε is a dielectric constant, S is the area of the overlapping region, and d is a thickness of the insulating layer. The insulating layer here can be but is not limited to a gate insulating layer. Any insulating layer can form an insulating layer for filtration, as long as it is provided between the metal wire and the common electrode.

Furthermore, as shown in FIG. 4, the thin film transistor array substrate provided in the embodiments of the present disclosure can further comprise, in addition to the metal wire 003, at least one perpendicular common electrode line 005 arranged in a gap between adjacent sets of the subpixel unit columns. Each perpendicular common electrode line 005 may be electrically connected with a corresponding common electrode 004 through at least one via. In a display mode, by inputting common electrode signals to the perpendicular common electrode line, resistance of the common electrode can be reduced and thereby the Greenish effect can be further improved. In addition, since the perpendicular common electrode line is arranged in a position at a gap between adjacent sets of the subpixel unit columns, it will not influence the aperture ratio.

In a specific embodiment, in the thin film transistor array substrate provided in the embodiments of the present disclosure, the perpendicular common electrode line can be arranged in a same layer as the data signal lines. In this way, no additional manufacturing process will be required for the manufacture of a TFT array substrate. It is only necessary to perform a one-time patterning process so as to form patterns of the perpendicular common electrode line and the data signal lines. Therefore, the manufacture cost can be saved and the added value of a product will be promoted.

In a specific embodiment, the thin film transistor array substrate provided in the embodiments of the present disclosure can be applied in a liquid crystal panel of an advanced super dimension switch (ADS) type. Specifically, the common electrode in the thin film transistor array substrate is located in a lower layer as a plate electrode (closer to the base substrate), and the pixel electrode is located in an upper layer as a slit electrode (closer to the liquid crystal layer). That is to say, the pixel electrode is located above the common electrode with an insulating layer provided therebetween. Besides, the common electrode has a plate structure in a position corresponding to an opening region of each subpixel unit.

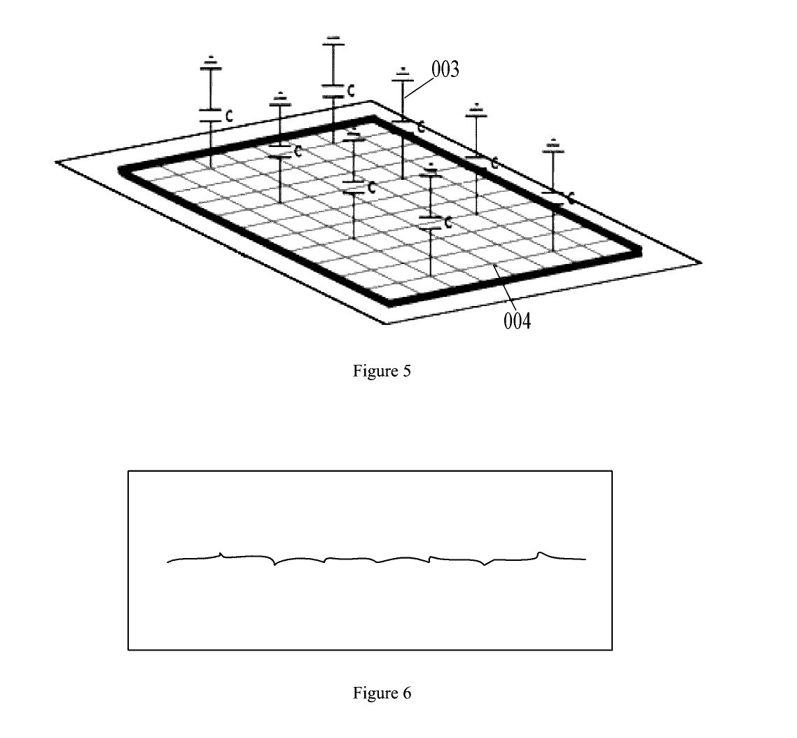

In a specific embodiment, the thin film transistor array substrate provided in the embodiments of the present disclosure can also be applied in a liquid crystal panel of a high advanced super dimension switch (HADS) type. Specifically, the pixel electrode in the thin film transistor array substrate is located in a lower layer as a plate electrode (closer to the base substrate), and the common electrode is located in an upper layer as a slit electrode (closer to the liquid crystal layer). That is to say, the pixel electrode is located below the common electrode with an insulating layer provided therebetween. Besides, the common electrode has a slit structure or a mesh structure in a position corresponding to an opening region of each subpixel unit. As shown in FIG. 5, the common electrode 004 has a mesh structure in a position corresponding to an opening region of each subpixel unit. In this case, resistance of the common electrode can be reduced and thus the Greenish effect of the liquid crystal display panel can be further improved.

It should be noted that the number of the metal wires 003 connected to a low-level potential can depend on the size of the filter capacitor. In other words, the size of the filter capacitor can be adjusted by the number of the metal wires. The specific number of the metal wires should depend on specific situations, which will not be limited here.

In a specific embodiment, the thin film transistor array substrate provided in the embodiments of the present disclosure further generally comprises structures such as a thin film transistor, a gate, a source-drain, an active layer or a planarization layer formed on the base substrate. These specific structures can be implemented in many different ways, which will not be limited herein.

A manufacturing method of the thin film transistor array substrate provided in the embodiments of the present disclosure will be explained in detail as follows with a specific example, and the following specific steps are comprised.

Firstly, forming patterns comprising a common electrode, a gate and gate signal lines on a base substrate. In a specific embodiment, patterns comprising a common electrode, a gate and gate signal lines are formed by a gate metal layer on the base substrate through a one-time patterning process, wherein two gate signal lines are provided between two adjacent rows of subpixel units.

Secondly, depositing a gate insulating layer on the base substrate on which patterns of the common electrode have been formed.

Then, forming patterns comprising a source-drain, data lines, a perpendicular common electrode line and a metal wire connected to a PCB ground point on the base substrate on which the gate insulating layer has been formed.

In a specific embodiment, patterns comprising a source-drain, data lines, a perpendicular common electrode line and a metal wire connected to a PCB ground point are formed by a source-drain metal layer on the base substrate through a one-time patterning process. Specifically, two adjacent columns of subpixel units form a set of subpixel unit columns. Each set of the subpixel unit columns shares a data signal line located between two columns of subpixel units, and a metal wire or a perpendicular common electrode line is arranged in a gap between adjacent sets of the subpixel unit columns. Besides, a projection of the metal wire on the base substrate and a projection of the common electrode on the base substrate may have an overlapping region, and the perpendicular common electrode line may be electrically connected with a corresponding common electrode through a plurality of vias.

The final step is to form patterns comprising a pixel electrode and an insulating layer having a pixel electrode via. In a specific embodiment, a pattern comprising an insulating layer having a pixel electrode via is formed on the base substrate through a one-time patterning process, and a pattern comprising a pixel electrode in a slit shape is formed on the insulating layer through a one-time patterning process. The pixel electrode is connected with the drain through the pixel electrode via.

So far, the thin film transistor array substrate provided in the embodiments of the present disclosure is manufactured through the above steps provided in the specific example.

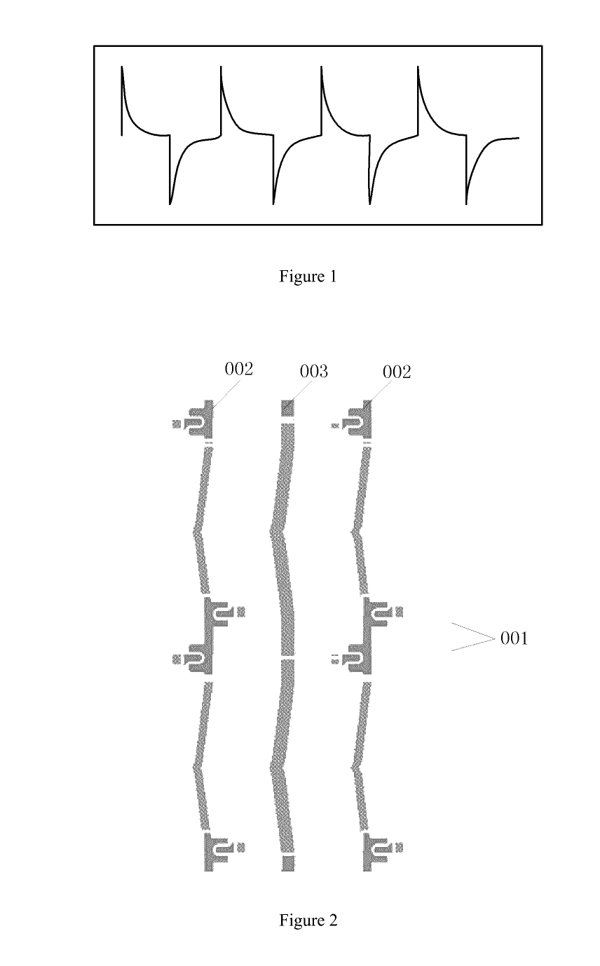

Specifically, a voltage fluctuation test is performed on the common electrode in the thin film transistor array substrate provided in the embodiments of the present disclosure. A test result as shown in FIG. 6 is compared with the schematic view for voltage fluctuations in the prior art as shown in FIG. 1. As can be seen, with an addition of a metal wire connected to a low-level potential, the DC voltage on the common electrode of the thin film transistor array substrate has small fluctuations and is hence stabilized. As a result, the Greenish effect is effectively improved and the image quality is greatly enhanced.

Based on a same inventive concept, the embodiments of the present disclosure further provide a liquid crystal display panel, comprising the thin film transistor array substrate provided in the above embodiments of the present disclosure. For implementations of the liquid crystal display panel, the above embodiments of the thin film transistor array substrate can be referred to, which will not be expounded for simplicity.

Based on a same inventive concept, the embodiments of the present disclosure further provide a display device, comprising the liquid crystal display panel provided in the above embodiments of the present disclosure. The display device can be any product or component having a display function, such as a handset, a tablet computer, a television, a display, a notebook computer, a digital photo frame, a navigator and the like. Other components which are indispensable for the display device are all comprised as understood by those skilled in the art, which will not be expounded for simplicity or regarded as limiting the present disclosure. For implementations of the display device, the above embodiments of the liquid crystal display panel and the thin film transistor array substrate can be referred to, which will not be expounded for simplicity.

The embodiments of the present disclosure provide a thin film transistor array substrate, a liquid crystal display panel and a display device. The thin film transistor array substrate comprises: a base substrate, a common electrode arranged on the base substrate and a plurality of subpixel units arranged in a matrix on the base substrate, wherein two gate signal lines are provided between two adjacent rows of subpixel units, and two adjacent columns of subpixel units form a set of subpixel unit columns, each set of the subpixel unit columns sharing a data signal line located between two columns of subpixel units. The thin film transistor array substrate further comprises: at least one metal wire arranged in a gap between adjacent sets of the subpixel unit columns and connected to a low-level potential, wherein a projection of the metal wire on the base substrate and a projection of the common electrode on the base substrate have an overlapping region. In this way, a filter capacitor is formed between the metal wire and the common electrode in the overlapping region, for filtering signals on the common electrode, which reduces coupling between signals on the data signal lines and signals on the common electrode and stabilizes signals on the common electrode. As a result, the Greenish effect of the liquid crystal display panel is effectively improved and the image quality is greatly enhanced. Besides, since the metal wire is arranged in a position at a gap between adjacent sets of the subpixel unit columns, it will not influence the aperture ratio.

Obviously, those skilled in the art can make various modifications and variations to the present disclosure without deviating from the spirits and scopes of the present disclosure. Thus, if these modifications and variations to the present disclosure fall within the scopes of the claims of the present disclosure and the equivalent techniques thereof, the present disclosure is intended to include them too.

1. A thin film transistor array substrate, comprising: a base substrate, a common electrode arranged on the base substrate and a plurality of subpixel units arranged in a matrix on the base substrate, wherein two gate signal lines are provided between any two adjacent rows of subpixel units, and any two adjacent columns of subpixel units form a set of subpixel unit columns, each set of the subpixel unit columns sharing a data signal line located between two columns of subpixel units; the thin film transistor array substrate further comprising:
at least one metal wire arranged in a gap between adjacent sets of the subpixel unit columns and connected to a low-level potential, wherein a projection of the metal wire on the base substrate and a projection of the common electrode on the base substrate have an overlapping region.

2. The thin film transistor array substrate according to claim 1, wherein the metal wire is connected with a ground point of an external printed circuit board (PCB).

3. The thin film transistor array substrate according to claim 2, wherein the metal wire is arranged in a same layer as the data signal lines; and the common electrode is arranged in a same layer as the gate signal lines.

4. The thin film transistor array substrate according to claim 1, further comprising, in addition to the metal wire, at least one perpendicular common electrode line arranged in a gap between adjacent sets of the subpixel unit columns, wherein each perpendicular common electrode line is electrically connected with a corresponding common electrode through at least one via.

5. The thin film transistor array substrate according to claim 4, wherein the perpendicular common electrode line is arranged in a same layer as the data signal lines.

6. The thin film transistor array substrate according to claim 1, wherein a pixel electrode in the thin film transistor array substrate is located above the common electrode, and the common electrode has a plate structure in a position corresponding to an opening region of each subpixel unit.

7. The thin film transistor array substrate according to claim 1, wherein a pixel electrode in the thin film transistor array substrate is located below the common electrode, and the common electrode has a slit structure or a mesh structure in a position corresponding to an opening region of each subpixel unit.

8. A liquid crystal display panel, comprising the thin film transistor array substrate according to claim 1.

9. A display device, comprising the liquid crystal display panel according to claim 8.

10. The thin film transistor array substrate according to claim 2, wherein a pixel electrode in the thin film transistor array substrate is located above the common electrode, and the common electrode has a plate structure in a position corresponding to an opening region of each subpixel unit.

11. The thin film transistor array substrate according to claim 3, wherein a pixel electrode in the thin film transistor array substrate is located above the common electrode, and the common electrode has a plate structure in a position corresponding to an opening region of each subpixel unit.

12. The thin film transistor array substrate according to claim 4, wherein a pixel electrode in the thin film transistor array substrate is located above the common electrode, and the common electrode has a plate structure in a position corresponding to an opening region of each subpixel unit.

13. The thin film transistor array substrate according to claim 5, wherein a pixel electrode in the thin film transistor array substrate is located above the common electrode, and the common electrode has a plate structure in a position corresponding to an opening region of each subpixel unit.

14. The thin film transistor array substrate according to claim 2, wherein a pixel electrode in the thin film transistor array substrate is located below the common electrode, and the common electrode has a slit structure or a mesh structure in a position corresponding to an opening region of each subpixel unit.

15. The thin film transistor array substrate according to claim 3, wherein a pixel electrode in the thin film transistor array substrate is located below the common electrode, and the common electrode has a slit structure or a mesh structure in a position corresponding to an opening region of each subpixel unit.

16. The thin film transistor array substrate according to claim 4, wherein a pixel electrode in the thin film transistor array substrate is located below the common electrode, and the common electrode has a slit structure or a mesh structure in a position corresponding to an opening region of each subpixel unit.

17. The thin film transistor array substrate according to claim 5, wherein a pixel electrode in the thin film transistor array substrate is located below the common electrode, and the common electrode has a slit structure or a mesh structure in a position corresponding to an opening region of each subpixel unit.

18. A liquid crystal display panel, comprising the thin film transistor array substrate according to claim 2.

19. A liquid crystal display panel, comprising the thin film transistor array substrate according to claim 3.

20. A liquid crystal display panel, comprising the thin film transistor array substrate according to claim 4.
